(19) United States
(12) Patent Application Publication
(10) Pub. No.: US 2019/0363925 A1
(43) Pub. Date: Nov. 28, 2019

(54) Cybersecurity Alert Management System

(71) Applicant: Critical Start, Inc., Plano, TX (US)

(72) Inventors: Robert Davis, Plano, TX (US); Vasu Nagendra, Hoffman Estates, IL (US); Jordan Mauriello, Wylie, TX (US)

(73) Assignee: Critical Start, Inc.

(21) Appl. No.: 15/986,177

(22) Filed: May 22, 2018

(51) Int. Cl. H04L 12/24; G06F 9/54

(52) U.S. Cl. CPC H04L 41/069; G06F 9/542; H04L 41/22; H04L 41/0604

(57) ABSTRACT

A cybersecurity alert management system and method includes: a database storing a set of cybersecurity event filter records and a set of pre-defined action instructions; a processor in communication with cybersecurity tools that generate cybersecurity data; wherein the processor; generates a cybersecurity event record assigned at least one identifying attribute; compares the at least one attribute against the set of cybersecurity event filter records; when the at least one identifying attribute assigned to the cybersecurity event record does not match at least one of the pre-defined cybersecurity event filter records, generates an alert message that prompts an end user to investigate the cybersecurity event record; and when the at least one identifying attribute assigned to the cybersecurity event record matches at least one of the pre-defined cybersecurity event filter records, acts upon the cybersecurity event record in accordance with a selected pre-defined action instruction.

### BACKGROUND OF THE INVENTION

The present invention relates to the field of cybersecurity. More specifically, this disclosure describes both systems and methods for cybersecurity alert management.

More and more of the world's population and businesses are going online. Microsoft estimates that by 2020 four billion people will be online, twice the number that were online in 2017. This global rise in internet and computer usage has also seen a corresponding rise in the rate and scale of cybersecurity attacks. According to the United States Government, cybercrime caused 3 trillion dollars in worldwide damage in 2015. By 2021, the cost of cybercrime damage is expected to double to 6 trillion dollars annually.

In response to these massive losses, businesses and private citizens have begun to increase spending on cybersecurity. According to Gartner, Inc. information security spending reached over 80 billion dollars in 2016, with a projection of 1 trillion dollars to be spent in the area of cyber security between 2017 and 2021. This figure is tied directly to the volume and seriousness of cyberattacks in recent years. For example, in 2013, the energy company BP says it suffered 50,000 attempted cyber intrusions a day. This seems like an inordinate amount until compared to the Pentagon and National Nuclear Security Administration, who each reported getting around 10 million attempts a day.

Present cyber security solutions have advanced to the point that most of the attacks described above are detected by software and/or hardware components of cybersecurity systems. However, detection is only the first step in series of events which must occur to successfully fend off cyberattacks. Maybe counterintuitively, detection and generation of an alert in response to every potential cyberattack has created new issues, one of the biggest being alert tyranny. Alert tyranny is when the volume of security alerts grows so out of control it overwhelms staff, allows real breaches to go unnoticed, and precludes investigation of potential cyber intrusions.

The sheer volume of alerts that need to be reviewed drive up both the cost of cybersecurity support and the manpower requirements for a given organization's IT staff. According to one report, there will be 3.5 million unfilled cybersecurity jobs by 2021. This figure is in no small part thanks to the (potentially) millions of alerts generated each day by the unceasing series of cyberattacks carried out on every organization and government in the world.

Accordingly, there is a need for a cybersecurity alert management system that is capable of intelligently filtering alerts to reduce alert tyranny.

### BRIEF SUMMARY OF THE INVENTION

To meet the needs described above and others, the present disclosure details both systems and methods for cybersecurity alert management.

In one embodiment, the present subject matter is embodied in a large-scale enterprise application in which a cybersecurity alert management system collects all alert events generated by security tools such as firewalls, STEM, endpoint detection and response tools, IDS/IPS, etc., each of which may generate alerts based on interactions with internal and external systems. These alerts are generated by tools that monitor user activity, applications, and systems via capturing log events, endpoint data, network information, etc. all of which may be collated and addressed by the physically, or virtually, separate alert management system that embodies the teachings provided herein.

The alert messages contain details and information such as what program is making a change on a computer within the organizations internal network, if the action is being carried out via a computer external to the network, the type of change being made, etc. As each event is monitored by the system, it is assigned at least one of these identifying pieces of data. As the system identifies each event, it compares each event (based on the identifying data assigned) to one or more pre-defined criteria. If an event has been previously identified, the system is able to automatically identify an appropriate response to it going forward such as ignoring the event, classifying the event as informational, or escalating the event for resolution.

If an event is unknown to the system, the system prompts an end user to designate whether the event is acceptable (or not) and identify how the event should be dealt with in the future. From this point forward, the system automatically handles the previously unknown event (e.g., ignoring it or escalating it). Over time, the present system is adapted to account for a large number of computerized events automatically thereby greatly reducing the need for human intervention.

In one embodiment, a cybersecurity alert management system includes: a database storing a set of cybersecurity event filter records and a set of pre-defined action instructions; a processor in communication with the database and one or more cybersecurity tools that generate cybersecurity data in response to activity within a monitored network; a memory in communication with the processor, the memory storing program instructions that, when executed by the processor, cause the processor to; in response to receiving cybersecurity data from one or more of the cybersecurity tools, generate a cybersecurity event record and assign the cybersecurity event record at least one identifying attribute; compare the at least one attribute against the set of cybersecurity event filter records; when the at least one identifying attribute assigned to the cybersecurity event record does not match at least one of the pre-defined cybersecurity event filter records, generate an alert message that prompts an end user to investigate the cybersecurity event record; and when the at least one identifying attribute assigned to the cybersecurity event record matches at least one of the pre-defined cybersecurity event filter records, act upon the cybersecurity event record in accordance with a selected pre-defined action instruction.

In some examples of the system, the pre-defined action instruction is selected from a group comprising: ignoring the cybersecurity event record; discarding the cybersecurity event record; escalating the cybersecurity event record to an end user for further action; and generating a real-time alert message within a graphical user interface and, in response to escalating the cybersecurity event record to the end user for further action, the end user selects a pre-defined action instruction to be stored in the database that enables the system to automatically identify and address the previously unknown cybersecurity event record in the future.

In some versions of the system, the database automatically updates based on one or more of cybersecurity news sources, learning algorithms, and anonymized data collected from other cybersecurity alert management systems. In additional examples, the processor automatically creates a pre-defined action instruction and stores the pre-defined action instruction in the database in response to cybersecurity data matching a permissive use. In response to the prompt to the end user to investigate the cybersecurity event record, when the user determines the cybersecurity event record does not require investigation, the processor may update the cybersecurity event filter records and the set of pre-defined action instructions in the database. When the cybersecurity event record matches one of the cybersecurity event filter records in the set of cybersecurity event filter records, the processor may add, subtract, or modify of the cybersecurity event record in a post-processing step. In response to escalating the cybersecurity event record to the end user for further action, the processor may change an action instruction associated with at least one of the cybersecurity event records in the set of cybersecurity event filter records in the database.

In some examples of the system, the processor presents a graphical user interface that enables one or more end users to review and modify information associated with the cybersecurity event record. In additional examples, the processor presents a graphical user interface that enables one or more end users to review and modify information associated with the set of pre-defined action instructions.

A goal of the present invention is to alleviate alert tyranny common within modern cybersecurity solutions. Many organizations encounter millions of cybersecurity events a day and it is highly impractical if not impossible for human workers to review every event with sufficient detail. The present system avoids this by automating review of issues which have been previously addressed. This can dramatically reduce the number of cyber security alerts that need to be reviewed day-to-day and alleviate the burden created by an unmanageable number of alert messages.

A benefit of the present system is it reduces the manpower and recourses needed to monitor the cybersecurity of an organization. The present system reduces the number of events that must be reviewed on a day-to-day basis by orders of magnitude. This helps reduce the exponentially rising cost associated with cybersecurity. Additionally, the present system alleviates the tediousness of reviewing huge numbers of alerts, many of which are for the same events over and over. IT and cybersecurity workers are all human and being forced to review endless alert messages reduces attention to detail and may enable a cyberattack to slip through unnoticed. Worst yet, the dissatisfaction which comes from doing a tedious job over and over may cause otherwise skilled workers to leave for more interesting work, further exacerbating a shortage of workers in the cybersecurity field.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic of the components of an embodiment of a cybersecurity alert system.

FIG. 2 is a flow chart illustrating how the cybersecurity alert system shown in FIG. 1 addresses a detected cybersecurity event.

FIG. 3 is an example event record generated by the cybersecurity alert system.

FIG. 4 illustrates the setup of a pre-defined action instruction via the GUI of the cybersecurity alert system.

FIG. 5 is a mandatory fields data entry box of a pre-defined action instruction provided via the GUI of the cybersecurity alert system.

FIG. 6 is a cybersecurity incidents screen provided via the GUI of the cybersecurity alert system I.

FIG. 7 a reporting screen provided via the GUI of the cybersecurity alert system.

### DETAILED DESCRIPTION OF THE INVENTION

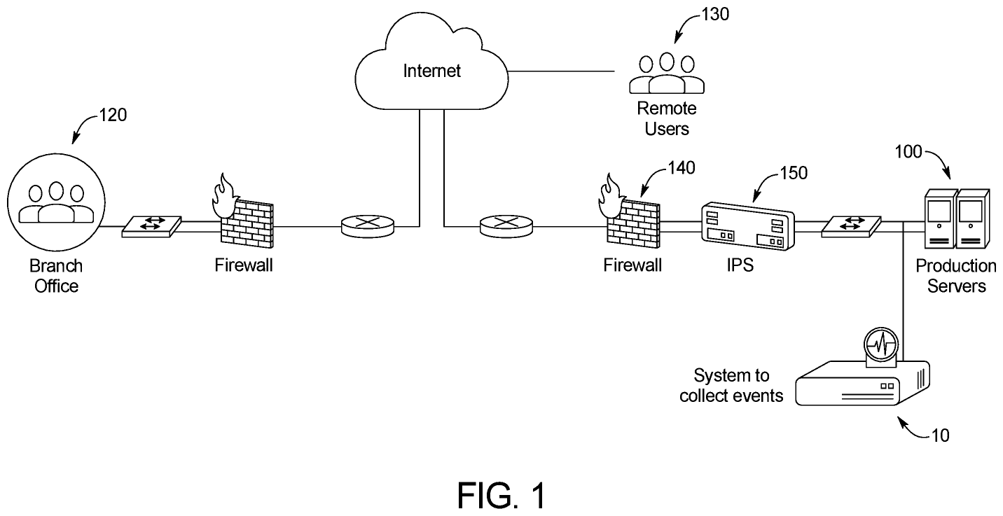

FIG. 1 illustrates an embodiment of a cybersecurity alert management system 10. In this embodiment, the alert management system 10 is a physically separate piece of computer hardware which is in communication with an organization's internal network. The internal network includes end user devices 120 and a centralized server (production servers in this example) 100. In this example, each of these physically separate pieces of hardware within the internal network of the organization are isolated from one another and external devices 130 via various cybersecurity tools. In the example shown, these tools include firewalls 140 and an intrusion prevention system 150. In other examples, the tools may also include IDS, SIEM, Active Directory, etc. Each of the various types of cybersecurity tools generate alerts, logs, messages, etc. that are transmitted to the cybersecurity alert management system 10.

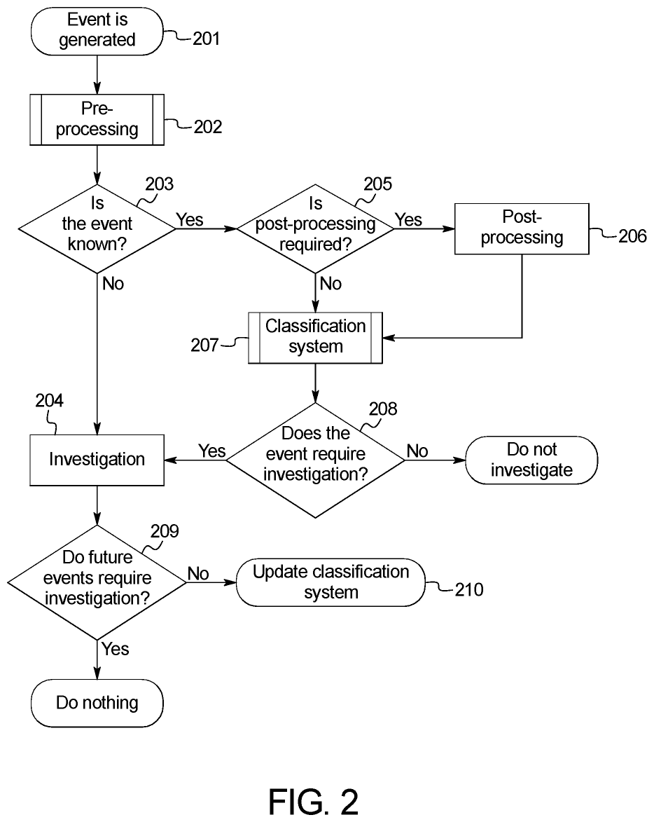

Communication of the security messages/alerts may be carried out via any mechanism of sending computerized data, including via Ethernet connection, Wi-Fi, Near Field communication (NFC), etc. In this embodiment, the alert management system 10 features its own processor and memory. As the security messages/alerts are transmitted to the alert management system 10, they may be reformatted to a consistent format to enable efficient processing of the various computerized messages that arrive to the alert management system 10 in potentially different formats (see FIG. 2). Alternatively, the various cybersecurity tools can be configured to report the security messages/alerts to the system 10 in a predefined format.

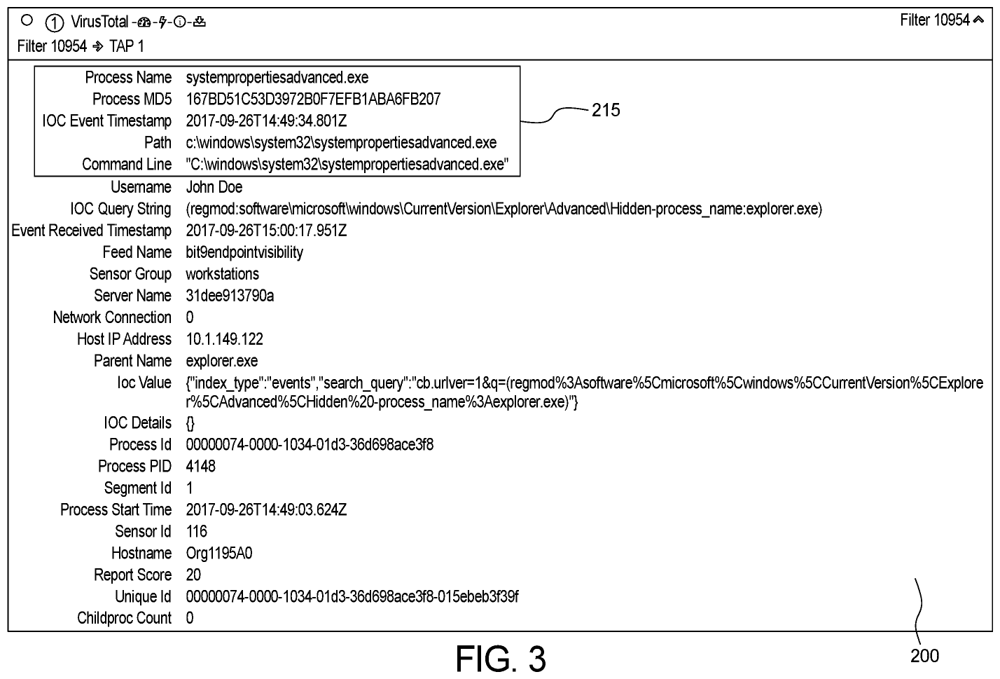

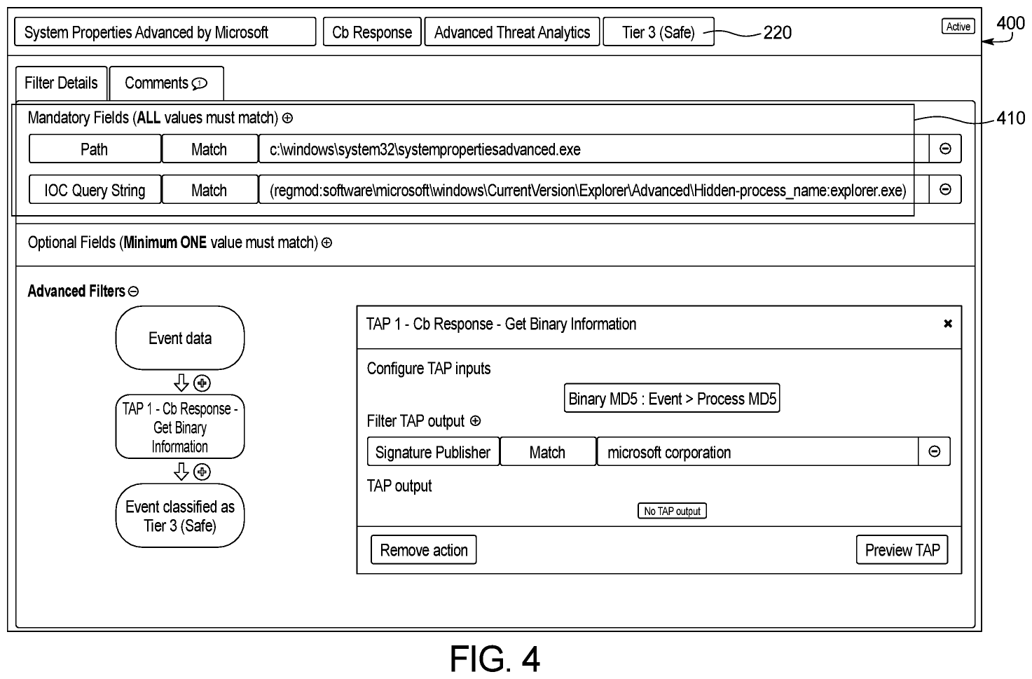

Once a computerized cybersecurity event is ingested by the present system 10, a cybersecurity event record 200 is generated by the system (see FIG. 3). The system 10 then assigns to this cybersecurity event record 200 at least one identifying attribute. Such attributes 215 can include hash values, dynamically generated metadata, etc. The attributes 215 are then compared against a pre-defined set of cybersecurity event filter records 400 (see FIG. 4) as part of steps 202 to 208 (See FIG. 2) by the system 10. In this example, one or more processors of the centralized sever 10 carry out this examination and, if the one or more attributes 215 assigned to the presently detected cybersecurity event record 200 match a pre-defined cybersecurity event filter record 400, the system 10 acts upon the detected cybersecurity event record 200 in accordance with a pre-defined action instruction 220 (see FIG. 4). In response to each incoming event, the system 10 carries out a defined action selected from the group including ignoring the event record 200 (e.g., automatically logging it with no further action taken), discarding the event, escalating it to an end user for further action, and even generating a real-time alert message within a graphical user interface (see FIG. 8), if the event record 200 warrants such action.

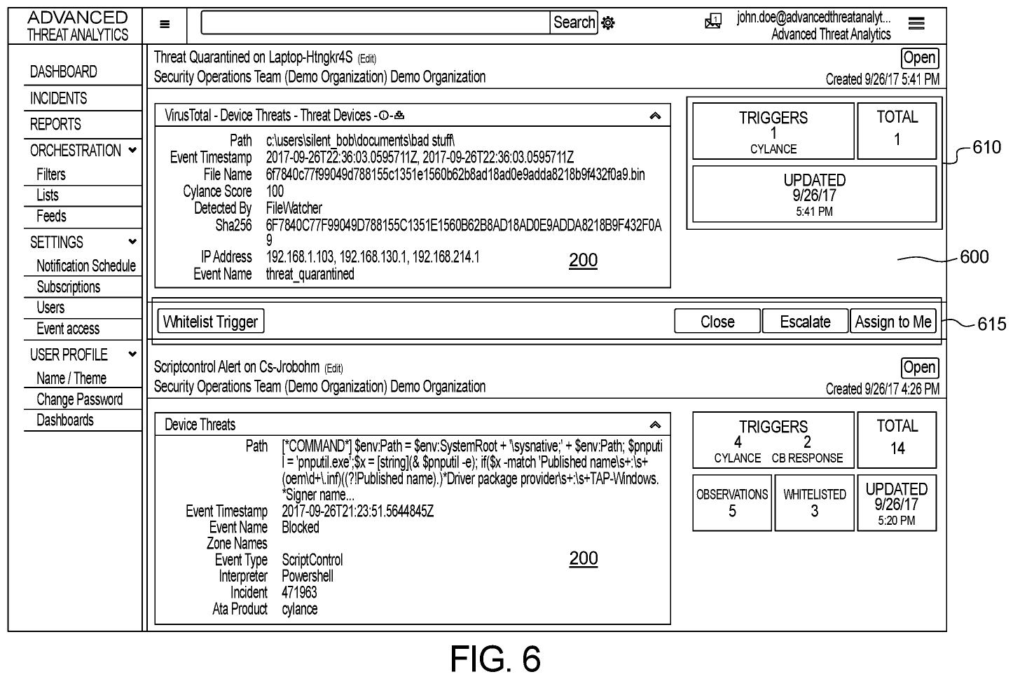

This example of the system 10 enables end users 120 such as cybersecurity workers to review the security incidents collected via a graphical user interface (see FIG. 6). Incidents are a related collection of one or more event records 200. For example, if the event record 200 detected does not match a pre-defined cybersecurity event filter record 400 the system 10 escalates the event record 200 to one or more end users for identification, resolution (if needed) and then selecting a pre-defined action instruction 220, which enables the system to automatically identify and address the previously unknown cybersecurity event record 200 in the future.

It should be noted that various aspects of this system can be automated and integrated with other cybersecurity solutions and/or external data sources. For example, the one or more databases the system 10 references when analyzing an event record 200 need not be manually updated in every instance. It is fully envisioned that the one or more databases referenced by the system 10 will be automatically updated based on cybersecurity news sources, learning algorithms, and even anonymized data collected from other instances of the system 10.

Additionally, the present system 10 is capable of self-correction and self-learning based on user habits. For example, if the same program of the same end user downloads a new file update every week (which is permitted by the organization), the system 10 can track this repeated, permissive use and automate the creation of a pre-defined cybersecurity event filter record 400, so that the system 10 would no longer alert an organization's cybersecurity team of such an event.

It should also be noted the present system 10 can be scaled upwards and downwards as needed depending on the size of an organization utilizing. The present system 10 can be used to manage incidents generated by one user all the way up to enterprise level cybersecurity applications. Each component mentioned can also be integrated into another as technology advances so if, for example, the system 10 is run as a standalone application on a smartphone, there may not be a need for a centralized coordinating server 10.

One example of the scalable and modular nature of the present invention is its integration into exists computer networking hardware. In some embodiments (not shown), the server 100 may act as a file server, communications server, production server, etc. and may also host one of more functional sets of programming code that receive security alerts from the systems that monitor every event relevant to cybersecurity carried out upon the internal end user devices 120 of a given organization. For example, if an end user downloads a file from an external file server (an external end user device 130), the centralized server 100 receives alerts related to this activity (via coding, programs, algorithms, sub-routines, etc.) from the and makes note of every event within the one or more databases. In some examples, the database may be part of the centralized server 100, but a database recording such events could also be stored on the internal end user devices 120 depending on the implementation of the system 10. This is just one example of how one or more pieces of existing computer hardware may have the present invention integrated depending on a organization's needs.

FIG. 2 is a flow chart which illustrates how a cybersecurity alert system 10 addresses a detected cybersecurity event. As shown at step 201, upon ingesting a cybersecurity event, an event record 200 is received and collected by the system 10. As mentioned previously, in response to detection of a cybersecurity event, information is transmitted to the system 10 from various cybersecurity tools (e.g., Cylance, Splunk, Protectwise, various other Anti-Virus or Anti-Malware, Firewalls, Physical Intrusion Detection Programs, etc.). After the event record 200 is generated, it then undergoes pre-processing at a second step 202. At this step (202), one or more attributes may be added to the event record 200 based on its content. The attributes assigned from the original cybersecurity event may act as way for the system 10 to reference one or more (internal or external) databases of known cybersecurity events, threat intelligence sources, etc. The system 10 in this example carries out such a comparison (steps 203-208), and if the event is unknown, the system prompts an end user to investigate the cybersecurity event (step 204) by generating an alert message. Additionally, the system 10 also ascertains a pre-defined action instruction 220 (see FIG. 4) which dictates whether the cybersecurity event, when detected in the future, should generate an alert, be ignored, etc. If after investigation 204 by the end user, the cybersecurity event 200 does not require investigation, then the end user will update the classification system 210 by modifying an existing or creating a new cybersecurity event filter record 400.

Alternatively, if the event record 200 is recognized by the system 10, the system 10 in this embodiment then examines whether post processing of the record 200 is required (step 205). Post processing can be any number of additions, subtractions, or modification of the event record 200. For example, an event record 200 generated because of a change to a program on an end user device 120 may be recognized by the present system 10. However, if, for example, this update is brand new file name associated with an otherwise permissible action (updating a program by an approved publisher), the initial recognition by the present system 10 may require some additional information to be added to the record 200 in order to efficiently classify how this recognized record 200 should be dealt with. If post-processing is required, the system 10 adds, subtracts, or alters the event record 200 as needed to make it easier to classify and act upon (step 206).

It should be noted that the post-processing steps 205 and 206 may utilize machine learning and/or external data sources for record 200 recognition and post-processing modification. Continuing the example above, if a program is running a regularly scheduled update, the system 10 may detect and identify this downloaded update as a cybersecurity event record 200. Since the system 10 has previously encountered updates downloaded by this program, it is able to identify the event record 200 as such, but the system 10 may need to deduce how the event record 200 should be handled as the file name of the downloaded update is likely different from previously downloaded update files. The system 10 may handle such a situation by, for example, examining an external database which features verified cybersecurity updates and their corresponding file names. The system 10 may then review the downloaded file to verify it matches the name, file extension type, size, etc. as reported for the given update. Once this additional information is verified, the system can then action (or not action) the update in concordance with the pre-defined action instruction 220 set-up for other, previous program updates.

Once an event record 200 (see FIG. 3) has sufficient detail associated with it, the system 10 then classifies (step 207) the event record 200 and determine if the record 200 is of a magnitude which requires investigation (e.g., a high-level alert) or does not require investigation (step 208). If investigation is required, the end user investigating the issue may be prompted with the option to change the action instruction 220 for the event record 200 so that in the future the system 10 will handle the alert differently (step 209) when detected (step 203). If updated, this information is used to update how an alert is identified and acted upon (step 210).

FIG. 3 is an event record 200 generated by a cybersecurity tool and sent to the alert system 10. As shown in FIG. 3, the system 10 may feature a graphical user interface (GUI) which enables end users to review information collected and stored by the system 10. As previously mentioned, the system 10 may monitor the computer activity of an organization including downloads, end user device changes, etc. When such an event occurs, the present system 10 may make note of it in the form of an event record 200 which details various information about the cybersecurity event which occurred. The event record 200 shown details information such as computer process name, type of change being made, the user making the change, as well as various additional details which enable the system 10 to identify the nature of the cybersecurity event which has occurred. This information is stored in various data fields 215 which appear on the event record 200.

The event record 200 shown is for a cybersecurity event previously unknown to the system 10. It is for a process titled “systempropertiesadvanced.exe” which is altering the registry for the workstation (end user device 120). Registry modification could be malicious in some situations thus making this a cybersecurity event and a security analyst or other end user should investigate the matter to determine if it is malicious or not. It should be noted that the various data fields 215 detailed in this embodiment can change depending on the functionality needed. Additionally, each data field 215 might be populated by initial detection or by the system 10 at a later point (post-processing) to aid in analysis and escalation (if needed).

It should be noted that the present system 10 may receive the event record 200 from a cybersecurity tool (e.g., firewall, antivirus program, etc.) or can generate the records itself if the alert management system 10 is integrated into such a cybersecurity tool.

FIG. 4 is a pre-defined action instruction 220 being set up via the GUI of a cybersecurity alert system 10. As shown in FIG. 4, once an event record 200 is generated it may then be investigated by an end user such as a cyber security analyst. In this example, after investigation by an analyst, it is determined that the event record 200 is normal and it is permissible for the program identified to modify the registry location targeted. In this situation, a pre-defined action instruction 220 (e.g., a filter) is created which marks event incident records 200 which match this registry change as safe when detected in the future. The record created is called a cybersecurity event filter record 400 and includes the pre-defined action instruction(s) 220 as well as other metadata about how the system 10 is to address a given event record 200.

The manner by which the system 10 determines if a pre-defined action instruction 220 applies to a given event record 200 is via the mandatory fields data entry box 410. In this example, the pre-defined action instruction 220 is set to apply to the detected registry change by the program “systempropertiesadvanced.exe”. Since this is permissible, the end user has noted it as “Tier 3” which, in this example means in the future, when an event record 200 is generated for the program “systempropertiesadvanced.exe” making this specific registry change again, the event record 200 will not be escalated to an end user.

It is fully realized that the present system may create these filters (pre-defined action instructions 220) via the mostly manual process described above as well as partially and fully automated processes as well. For instance, the system 10 may monitor one or more external data sources for cybersecurity news so, if a malware company secretly buys the makers of “systempropertiesadvanced.exe” and integrates malware into it, once this information is discovered the system 10 may automatically remove or alter the filter associated with the program to raise the alarm automatically.

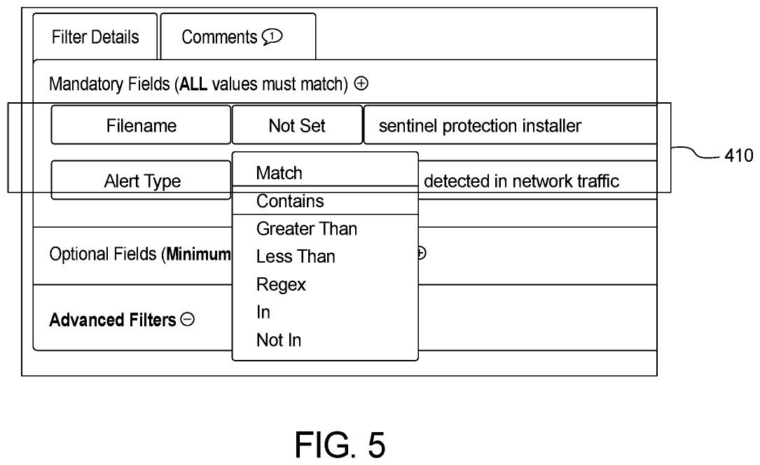

FIG. 5 is a mandatory fields data entry box 410 of a pre-defined action instruction 220. As shown in FIG. 5, the mandatory fields data entry box 410 of a pre-defined action instruction 220 may be set to many different settings which enable the system 10 to properly action a wide range of cybersecurity events. In this embodiment, the program “sentinel protection installer” is being set-up to be permissible when “detected in network traffic”. This is because “sentinel protection installer” is a trusted and verified source of updates for a computer program the end users of an organization need. Accordingly, rather than set up an induvial allowance for each new update file (as would be the case with the example in FIG. 4) the end user is instead setting up a pre-defined action instruction 220 for all “sentinel protection installer” traffic on the organizations network which tells the system 10 that this traffic is safe and does not need to be investigated by an end user.

FIG. 6 is a cybersecurity incidents screen 600 of the system's 10 GUI. As shown in FIG. 6, the present system may feature an end user GUI with various screens useful for the review of cybersecurity incidents, alterations to system 10 settings, and reporting tools. The cybersecurity incidents screen 600 shown enables a cybersecurity professional to review high level and unknown cybersecurity threats which are not filtered out by the system 10. The cybersecurity incidents screen 600 displays event incident records 200 as well as associated incident record metadata 610. This metadata includes information concerning how other end users have dealt with the event record 200 (if available) and how often such events are occurring. There are also shortcut buttons 615 to edit the whitelist trigger for a given record, close a record, escalate a record, or assign the record to the end user for investigation.

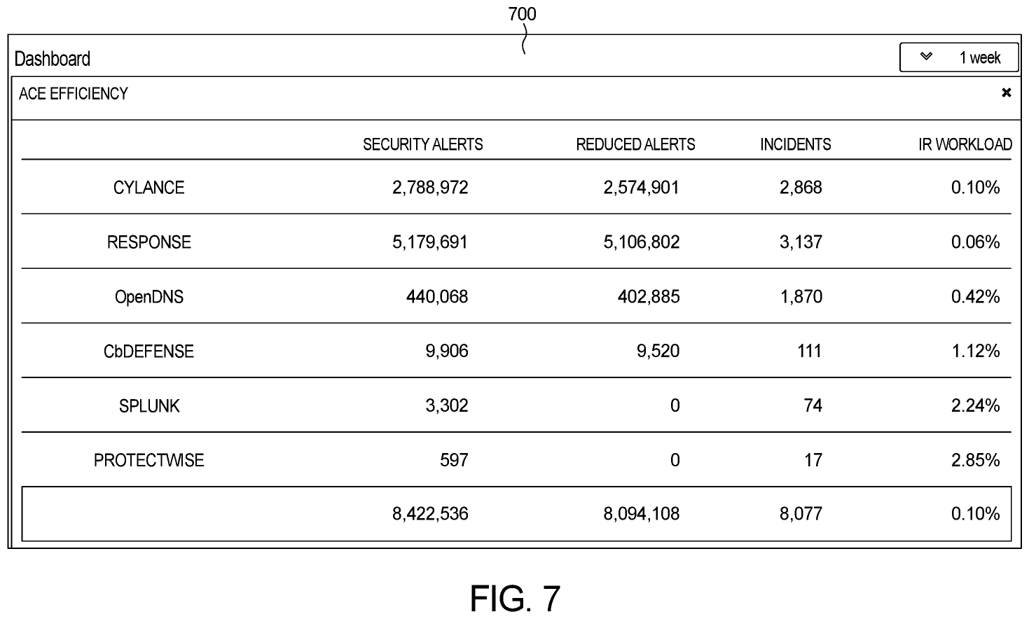

FIG. 7 a reporting screen 700 of the system's 10 GUI. As shown in FIG. 7, the system's GUI may feature a reporting screen 700 which can display useful information. In this example, the report shown demonstrates the system's 10 efficiency in reducing the number of event incident records 200 which require investigation by a human end user. The event incident records 200 (termed security alerts in this embodiment) are generated by various cybersecurity solutions which all feature data integration with the present system 10. As the alerts are generated by these other cybersecurity platforms, they are acted upon by the system 10 in accordance with existing pre-defined action instructions 220 to dramatically reduce the number of security alerts which must be reviewed by cybersecurity analysts, etc. improving their efficiency and efficacy.

As noted above, the primary embodiments of the cybersecurity alert management system 10 include a physically separate piece of computer hardware in communication with an organization's internal network. However, as will be understood by those skilled in the art, the features and functions of the cybersecurity alert management system 10 provided herein may be embodied in the components of the organization's internal network, including any one or more of the centralized server 100, the end user devices 120, and/or any of the security tools such as the firewalls, STEM, endpoint detection and response tools, IDS/IPS, etc.

It should be noted that various changes and modifications to the presently preferred embodiments described herein will be apparent to those skilled in the art. Such changes and modifications may be made without departing from the spirit and scope of the present invention and without diminishing its attendant advantages.

1. A cybersecurity alert management system comprising:
a database storing a set of cybersecurity event filter records and a set of pre-defined action instructions;
a processor in communication with the database and one or more cybersecurity tools that generate cybersecurity data in response to activity within a monitored network;
a memory in communication with the processor, the memory storing program instructions that, when executed by the processor, cause the processor to;
in response to receiving cybersecurity data from one or more of the cybersecurity tools, generate a cybersecurity event record and assign the cybersecurity event record at least one identifying attribute;
compare the at least one attribute against the set of cybersecurity event filter records;
when the at least one identifying attribute assigned to the cybersecurity event record does not match at least one of the pre-defined cybersecurity event filter records, generate an alert message that prompts an end user to investigate the cybersecurity event record; and
when the at least one identifying attribute assigned to the cybersecurity event record matches at least one of the pre-defined cybersecurity event filter records, act upon the cybersecurity event record in accordance with a selected pre-defined action instruction.

2. The system of claim 1 wherein the pre-defined action instruction is selected from a group comprising: ignoring the cybersecurity event record; discarding the cybersecurity event record; escalating the cybersecurity event record to an end user for further action; and generating a real-time alert message within a graphical user interface.

3. The system of claim 2 wherein, in response to escalating the cybersecurity event record to the end user for further action, the end user selects a pre-defined action instruction to be stored in the database that enables the system to automatically identify and address the previously unknown cybersecurity event record in the future.

4. The system of claim 1 wherein the database automatically updates based on one or more of cybersecurity news sources, learning algorithms, and anonymized data collected from other cybersecurity alert management systems.

5. The system of claim 1 wherein the processor automatically creates a pre-defined action instruction and stores the pre-defined action instruction in the database in response to cybersecurity data matching a permissive use.

6. The system of claim 1 wherein in response to the prompt to the end user to investigate the cybersecurity event record, when the user determines the cybersecurity event record does not require investigation, the processor updates the cybersecurity event filter records and the set of pre-defined action instructions in the database.

7. The system of claim 1 wherein, when the cybersecurity event record matches one of the cybersecurity event filter records in the set of cybersecurity event filter records, the processor adds, subtracts, or modifies of the cybersecurity event record in a post-processing step.

8. The system of claim 1 wherein, in response to escalating the cybersecurity event record to the end user for further action, the processor changes an action instruction associated with at least one of the cybersecurity event records in the set of cybersecurity event filter records in the database.

9. The system of claim 1 wherein the processor presents a graphical user interface that enables one or more end users to review and modify information associated with the cybersecurity event record.

10. The system of claim 1 wherein the processor presents a graphical user interface that enables one or more end users to review and modify information associated with the set of pre-defined action instructions.

11. A method of providing a cybersecurity alert management system comprising the steps of:
providing a database storing a set of cybersecurity event filter records and a set of pre-defined action instructions;
providing a processor in communication with the database and one or more cybersecurity tools that generate cybersecurity data in response to activity within a monitored network;
providing a memory in communication with the processor, the memory storing program instructions that, when executed by the processor, cause the processor to;
in response to receiving cybersecurity data from one or more of the cybersecurity tools, generate a cybersecurity event record and assign the cybersecurity event record at least one identifying attribute;
compare the at least one attribute against the set of cybersecurity event filter records;
when the at least one identifying attribute assigned to the cybersecurity event record does not match at least one of the pre-defined cybersecurity event filter records, generate an alert message that prompts an end user to investigate the cybersecurity event record; and
when the at least one identifying attribute assigned to the cybersecurity event record matches at least one of the pre-defined cybersecurity event filter records, act upon the cybersecurity event record in accordance with a selected pre-defined action instruction.

12. The method of claim 11 wherein the pre-defined action instruction is selected from a group comprising: ignoring the cybersecurity event record; discarding the cybersecurity event record; escalating the cybersecurity event record to an end user for further action; and generating a real-time alert message within a graphical user interface.

13. The method of claim 12 wherein, in response to escalating the cybersecurity event record to the end user for further action, the end user selects a pre-defined action instruction to be stored in the database that enables the system to automatically identify and address the previously unknown cybersecurity event record in the future.

14. The method of claim 11 wherein the database automatically updates based on one or more of cybersecurity news sources, learning algorithms, and anonymized data collected from other cybersecurity alert management systems.

15. The method of claim 11 wherein the processor automatically creates a pre-defined action instruction and stores the pre-defined action instruction in the database in response to cybersecurity data matching a permissive use.

16. The method of claim 11 wherein in response to the prompt to the end user to investigate the cybersecurity event record, when the user determines the cybersecurity event record does not require investigation, the processor updates the cybersecurity event filter records and the set of pre-defined action instructions in the database.

17. The method of claim 11 wherein, when the cybersecurity event record matches one of the cybersecurity event filter records in the set of cybersecurity event filter records, the processor adds, subtracts, or modifies of the cybersecurity event record in a post-processing step.

18. The method of claim 11 wherein, in response to escalating the cybersecurity event record to the end user for further action, the processor changes an action instruction associated with at least one of the cybersecurity event records in the set of cybersecurity event filter records in the database.

19. The method of claim 11 wherein the processor presents a graphical user interface that enables one or more end users to review and modify information associated with the cybersecurity event record.

20. The method of claim 11 wherein the processor presents a graphical user interface that enables one or more end users to review and modify information associated with the set of pre-defined action instructions.
